(19) United States
(12) Patent Application Publication
(10) Pub. No.: US 2015/0097700 A1
(43) Pub. Date: Apr. 9, 2015

(54) TEAM PERFORMANCE MONITORING

(71) Applicant: Catapult Innovations Pty Ltd, South Melbourne (AU)

(72) Inventor: Shaun HOLTHOUSE, Brighton East (AU)

(73) Assignee: Catapult Innovations Pty Ltd, South Melbourne (AU)

(21) Appl. No.: 14/045,954

(22) Filed: Oct. 4, 2013

(51) Int. Cl. G08C 17/02

(52) U.S. Cl. CPC G08C 17/02
USPC 340/870.03

(57) ABSTRACT

A system for monitoring a plurality of individuals engaged in a sporting activity includes a base station; a plurality of individual participant monitors, affixed to each individual and wirelessly communicating with said base station; a plurality of sensors in each said monitor or on each individual, in communication with each monitor and configured to sense a physiological or activity parameter of the individual; each monitor transmitting data relating to parameters sensed by said sensors to the base station; one or more group monitoring devices communicating wirelessly with said base station to receive said sensed parameter data. The system displays, during said activity, data relating to one or more sports parameters of one or more individuals as well as displaying the operational status of one or more of each monitor, each sensor, and the base station.

### FIELD OF THE INVENTION

This invention relates to a system and methods used in monitoring the performance in training and competition of sports teams individually and as a group.

### BACKGROUND OF THE INVENTION

U.S. Pat. No. 7,715,982 and U.S. Pat. No. 8,036,826 disclose devices for collecting data relating to movements in team sports such as passing and kicking balls and the impact of tackles as well as tracking the movements of individual players on the playing field.

U.S. Pat. No. 8,353,791 discloses the tracking of the ball during the game.

The statistical and analytical information collected by these devices provide developmental guides and insights for coaches and team members alike.

U.S. patent application No. 200710219059 discloses a system of sensors a to measure activity and to provide real-time analysis and display of the measured parameters such as heart rate to a coach and participants.

European patent application 2108311 discloses a group monitoring system including a plurality of body sensor units for participants which transmit data such as heart rate to a receiver unit which receives and stores the data and makes it available for display and analysis to a network.

### SUMMARY OF THE INVENTION

In a first embodiment the present invention provides a system for real time monitoring of participants in a sporting activity which comprises a plurality of participant monitors that include sensors to collect physiological and movement data for collection in a storage device in each of said monitors said monitors incorporating components for transmitting data collected a base station for receiving data from said monitors and for processing said data a supervising device for receiving data from said base station and programmed to facilitate analysis and display of information collected by said monitors.

More specifically the present invention provides a system for monitoring a plurality of individuals engaged in a sporting activity the system comprising:
a base station;
a plurality of individual monitors, carried on the person of each individual configured to communicate wirelessly with the base station;
a plurality of sensors, each sensor in communication with an individual monitor, each configured to be coupled to an individual and each sensor configured to sense a characteristic of the individual and to transmit, during the activity, data indicative of the characteristic to the individual monitor;
a group monitoring device configured to communicate wirelessly with the base station;
wherein each individual monitor is configured to transmit, during the activity, the data to the base station;
wherein the base station is configured to receive the data and to transmit during the activity a metric based on the data to the group monitoring device; and
wherein the group monitoring device is configured to display a representation of the metric.

The individual participant monitors are preferably as disclosed in U.S. Pat. No. 7,715,982 and U.S. Pat. No. 8,036,826, the disclosures of which are incorporated herein by reference in their entirety, and include GPS, 3 dimensional accelerometers and 3 dimensional gyro sensors and may also accept input from physiological sensors such as heart rate monitors. These sensors can provide data on parameters such as acceleration, distance and directions traveled, speed, heart rate and actions such as jumps, kicks, tackles, hand passes etc. The system is applicable to all team sports including all the football codes of American football, Rugby, Australian rules and soccer as well as games like hockey and basketball. Each participant sensor may be assigned to a particular player and the software in the device will include data on the identity and key personal data of the participant. The individual monitors are able to communicate bi directionally with the base station. Alternative participant sensors and systems that may be used in the system of this invention are disclosed in U.S. Pat. No. 8,033,959 and U.S. Pat. No. 8,105,208, the disclosures of which are incorporated herein by reference in their entirety.

The base station is a computer and antenna for receiving and transmitting data. Preferably the base station consists of a portable short range or long range antenna connected by USB or serial cable to a portable computer cable of receiving data from the participant monitors and transmitting data to the supervising or group monitoring devices. The system is designed to be portable and transportable. A bulk carry case for a plurality of participant monitors is provided to make management of the teams monitors easier. The carry case may include docking ports for each monitor so that the monitors' batteries can be recharged together and so that the data collected on each monitor can be down loaded by cable connection to the carry case, if desired. The carry case incorporates a rechargeable battery and is in communication with the base station computer so that the status of the monitors in the carry case may be checked and so that data from the monitors in the carry case can be down loaded to the base station computer.

The base station antenna and computer may also be incorporated into the carry case to further centralize the control of the system components. This enables the team monitors to be managed in an orderly fashion. The base station computer is in communication with a web based server and database so that data may be down loaded to the web server or uploaded from the web server.

The system software embodied in the individual monitors and on the base station computer and the group monitoring devices includes computer programs that analyse and transform the data from the sensors to produce metrics or parameters relating to physiological characteristics of the individual or of characteristics of the individuals performance during the activity. The data from the sensors is indicative of heart rate, speed, distance traveled, acceleration, location, orientation and heading of the individual. The system software has a suite of programs to transform the data into metrics indicative of heart rate, speed, distance traveled, acceleration, location, orientation, heading, energy expenditure, power output and performance effectiveness of the individual. The system software on the base station computer or the group monitors is able to store data and metrics for retrieval and display.

The supervising or group monitoring device may be a programmed portable computing device as used by a coach and is programmed to display selected parameters for one or more of the participants involved in the activity. This group monitoring device is preferably portable. The portable computing device may be a laptop, notebook, or a mobile phone or handheld programmable device. Control of the display may be by keyboard touch screen or pointing devices as is common with portable computing devices. The display is programmed to show data or a representation of the data from all of the participant monitors and to indicate the status of each monitor. The display is programmed with the system software to allow the user to manipulate the display to select parameters for display and comparison between individual participant's data.

The base station may also be used as a supervising or group monitoring device. When the coach or assistant uses the supervising device it is programmed with the system software to display data collected from the participant monitors in any desired form such as tables, graphs or graphical representations of the playing field and participants movements over the playing field. The data will include the identity of the participant and all parameters collected on the monitor assigned to that participant. The display may be configured to show data relating to more than one participant so that a screen display may show selected parameters for a group or team of players. The program used to present the displays also allows the user or coach to manipulate the display and to check or adjust the operation of components in the system. In particular the supervising program can check the operational status and power available to the base station, the antennas and to each participant monitor. For portable devices the remaining battery life is a key status parameter. It is also important that each participant monitor includes a program to report on the status of its components particularly its sensor components. The system status report also includes a report on the transmission and receiver signal strength to assist in the optimum positioning of the antennas. Where GPS is used, the system status report will include a report on the GPS signal strength for the system as a whole and for each participant monitor. The status report will indicate which of the participant monitors are active and allow the coach to ensure that all participants in the training session or game are being monitored.

It is also within the scope of this invention to include a ball monitor in the system so that the movement of the ball over the playing field can be measured as well as determining which participants are in possession of the ball or are contesting the ball. For this purpose it is preferred to use the ball tracking system disclosed in U.S. Pat. No. 8,353,791, the disclosure of which is incorporated herein by reference in its entirety. Other object sensors may be linked to the participant monitors such as strain sensors on oars in a rowing shell. Such arrangements are disclosed in U.S. Pat. No. 7,715,982 and U.S. Pat. No. 7,272,499, the disclosures of which are incorporated herein by reference in their entirety.

In another aspect this invention provides a method of electronically monitoring a plurality of individuals engaged in a sporting activity which comprises:
displaying during said activity data relating to one or more sports parameters of one or more individuals;
displaying during said activity the operational status of each participant monitor, a sensor in communication with said monitor and the base station.

In more detail a preferred method of electronically monitoring a plurality of individuals engaged in a sporting activity comprises:
providing each individual with a participant monitoring device which includes a wireless transmitter and is in communications with a plurality of sports parameter sensors located in the device or on the individual and wirelessly transmitting data from said sensors during said activity;
providing a base station including a wireless receiver and a wireless transmitter to receive said data from said individual monitors and to wirelessly transmit data;
providing group monitoring devices portable relative to the base station, said group monitoring devices being able to receive wireless signals and during said activity receiving data relating to one or more sports parameters from one or more participant monitors;
displaying on said group monitors data relating to the sports parameters of one or more individuals.

The software for the base station computer and the portable computer devices used as supervising or group monitors includes the ability for the user to select what parameters are displayed for each sports participant. There are some parameters such as component status, battery life and activity alerts that may be displayed over the selected parameter display when certain threshold values are exceeded. These may include low battery life, low signal quality or high or irregular heart rates or high impact readings from player collisions or tackles.

During a game where interchange of players is allowed, statistics such as distance traveled or total energy used by a player within a particular on field time interval may be used as alerts to guide interchange decisions. The software allows ranges to be selected for display of parameters and for time intervals for displayed parameters. If during an activity an individual's parameters such as speed or distance traveled falls outside of the range an alert may be triggered. The base station is configured by the software to transmit a notification to the group monitoring device in response to a metric of an individual being outside the range.

The group display screen allows side by side comparison of players and selected game statistics. In training sessions a participants workload or activity statistics may be displayed for comparison with prior performance statistics for that player or against targets set for that player. The metric or the data may be displayed in any suitable format that constitutes a representation of the data. The data may be in table form or graphical form and the graph may be a line or bar graph or a pie chart.

In addition to data from the individual monitors, data in the form of video images may be added by including in the system a camera configured to obtain image information related to individuals and to transmit the image information to the base station during the activity. The software used in the group monitoring devices is able to combine and synchronise video of the sporting activity with the parameter data and metrics and display the combination on a screen. The video data may be transmitted to the web server and be accessed from the web server.

The game parameters that the participant monitors are programmed to collect may be customised by the coach. The GPS and accelerometer sensors enable the collection of parameters such as:
Location of participant on the playing field at any moment in time
Distance covered over playing time intervals
Tracking of the player movements over the playing field time at low moderate and high speeds
Average speed during a playing interval
Low moderate and top accelerations
Orientation of the player
Speed backwards
Acceleration in turns or changes of direction
Total effort expended
Tackle impact
Number of kicks, passes and ball receives

The combination of parameters from all participants in a game allows for mapping of attacking and defensive structures.

Physiological sensors in particular heart rate monitors, allow the display of parameters such as time at low medium and high heart rate as well as averages. Alerts based on high or irregular heart rates may be displayed.

This invention also provides a computer program product comprising a computer usable medium having program logic recorded thereon so that when executed by one or more processors provides a display of one or more sports parameters relating to a sporting activity of one or more individuals participating in the activity, during the activity.

The software used in the supervisor or group monitors includes the ability for the user to manipulate the parameters and data displayed in real time during a training session or a game. During a training session the coach may want to compare the performance of participants during a particular time interval or over a particular distance. The metric may be a relative metric which provides an indication of a level of performance of its associated individual, relative to personal ability of the associated individual. Thus historical data from previous games or training sessions will allow the coach to create a reference value for any selected metric so that any displayed value can be compared to the reference value and be given a relative value. The relative metric is based on a calibration assessment activity to establish the reference value.

In another aspect this invention provides a method for monitoring a plurality of individuals engaged in an athletic activity, comprising:
displaying during the athletic activity a plurality of individual performance metric information relating to a plurality of individuals engaged in the athletic activity, each performance metric relating to one of a plurality of individuals;
providing first and second analysis markers adapted to be manipulated by a user to define a subset of the displayed performance metric information as a function of an interval parameter; and
displaying performance metric information corresponding only to a subset of the displayed performance metric information defined by the analysis markers for each of a plurality of individuals.

The activity being monitored may be a conditioning drill, a strength training drill or a skills drill for a particular sport and the intervals may be distance or time.

To implement this method the invention provides computer program product comprising a computer-usable medium having computer program logic recorded thereon that, when executed by one or more processors, provides to a user performance information related to an athletic activity engaged in by a plurality of individuals, the computer program logic comprising:
first computer readable program code that enables a processor to display during the athletic activity a plurality of individual performance metric information relating to a plurality of individuals engaged in the athletic activity, each performance metric relating to one of the plurality of individuals;
second computer readable program code that enables a processor to provide first and second analysis markers adapted to be manipulated by a user to define a subset of the displayed performance metric information as a function of an interval parameter; and
third computer readable program code that enables a processor to display performance metric information corresponding to only the subset of the displayed performance metric information defined by the analysis markers for each of the plurality of individuals.

It is also within the scope of the system of this invention to combine the viewing of live data with viewing of stored data from previous games or training sessions or from other statistical databases. Access to these data bases may be by internal or external storage or over a network such as the internet. Access to stored data is useful in strategic analysis or in sports presentations on television. The software allows the various programs and functions described above to be carried out on the base station computer; on a group monitoring device or on the web server.

The software is defined as a computer readable medium having computer program logic recoded on it such that when the program is executed the processor is able to display on the screen data in relating to individual performance in table format, graphical or map formats.

### BRIEF DESCRIPTION OF THE DRAWINGS

Preferred embodiments of the invention will now be described with reference to the drawings in which:

FIG. 1 depicts a storage and charge case for a teams participant monitors;

FIG. 2 depicts a participant monitor;

FIG. 3 depicts the monitor set up screen;

FIG. 4 depicts a screen shot of the download page of the software for managing the participant monitors and the data collected;

FIG. 5 depicts the graph set up page for the software;

FIG. 6 depicts the settings page for the software;

FIG. 7 depicts the page for downloading raw data from participant monitors;

FIG. 8 depicts a graphical report page displaying data downloaded from a participant monitor;

FIGS. 9, 10 and 11 illustrate the screen pages used for selection of a time interval for presentation of the data;

FIGS. 12 and 13 illustrate the screen pages for selecting and viewing velocity bands;

FIGS. 14 and 15 illustrate the generation of reports from the wireless screen;

FIG. 16 illustrates a screen for displaying data related to multiple players;

FIG. 17 illustrates the antenna used for the base station; and

FIG. 18 illustrates the synchronisation of data files with video images.

### DETAILED DESCRIPTION

The following published applications similarly disclose systems and processes for monitoring athlete and team performance: U.S. patent publication No. 20120253484, published Oct. 4, 2012; U.S. patent publication No. 20120254934, published Oct. 4, 2012; and U.S. patent publication No. 20130041590, published Feb. 14, 2013. The disclosures of each of these U.S. patent publications are incorporated herein by reference in their entirety.

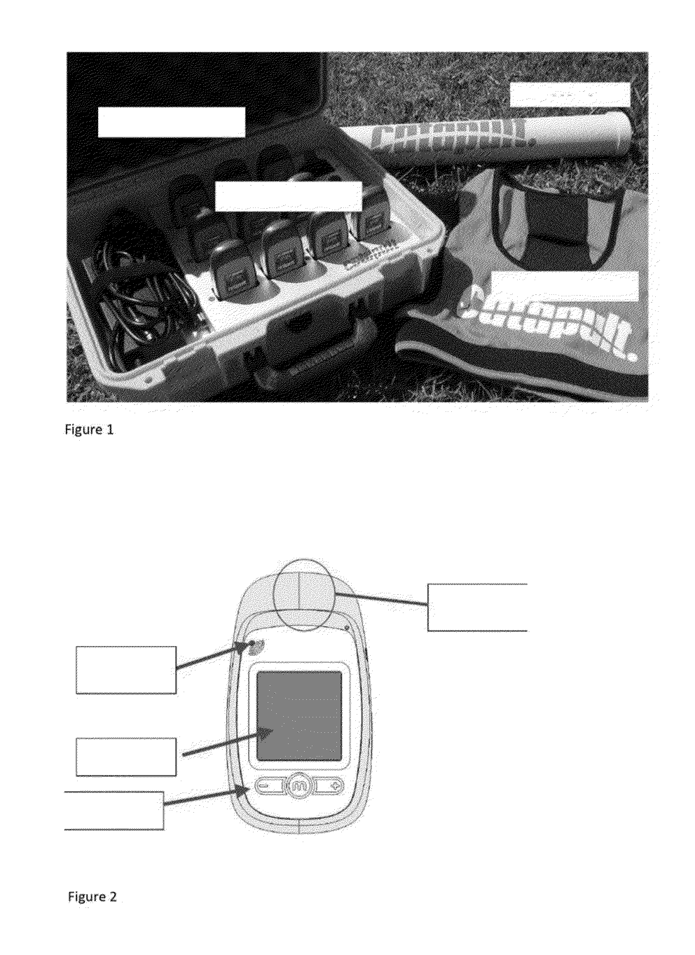

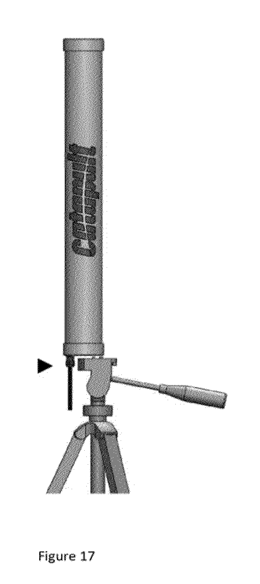

With reference to FIGS. 1 and 2 the participant monitors of FIG. 2 can be charged and data down loaded from the carry case depicted in FIG. 1 the monitor has an LED status indicator 11 a screen 12 and actuation buttons 13. These monitors incorporate a GPS antenna 15. These are described in U.S. Pat. No. 7,715,982 and U.S. Pat. No. 8,036,826 and include GPS, 3 dimensional accelerometers and 3 dimensional gyro sensors and also accept input from heart rate monitors. These monitors also include an antenna for wireless transmission of data to a base station computer or to a supervising portable computer device. The base station is a portable computer connected to an antenna as shown in FIG. 17.

The monitor as shown is switched on by pressing the m button. The LED begins blinking green fast if the unit has adequate battery charge, or red fast if the battery charge is low. The colour LCD screen displays the battery charge level and the GPS status.

When the GPS in the monitor has locked on, a message will appear on the screen, and the LED will begin blinking slowly (once every 2 seconds).

To turn the unit off, depress the “m” button for 2 seconds.

The unit has approximately 4-5 hours of battery life when fully charged.

The monitors may be charged and data uploaded to a storage device or computer either singly or using the case as shown in FIG. 1 multiple monitors may be charged and uploaded at one time.

The participant monitors include processors to receive and analyse the data from the sensors and transform the data into a parameter measurement. For example the distance traveled parameter is calculated from the changes in the GPS location and speed is calculated from accumulating the accelerometer data over time or deriving it from the distance traveled over time.

Participant monitors are worn in different positions on the body depending on the sport being played. Preferably a vest is used which secures the monitor in a protective pouch which positions the monitor in the optimum position on the participant. The vest may also contain a heart rate monitor. In some sports the unit is fixed to an apparatus. In rowing the monitor is fixed to the boat.

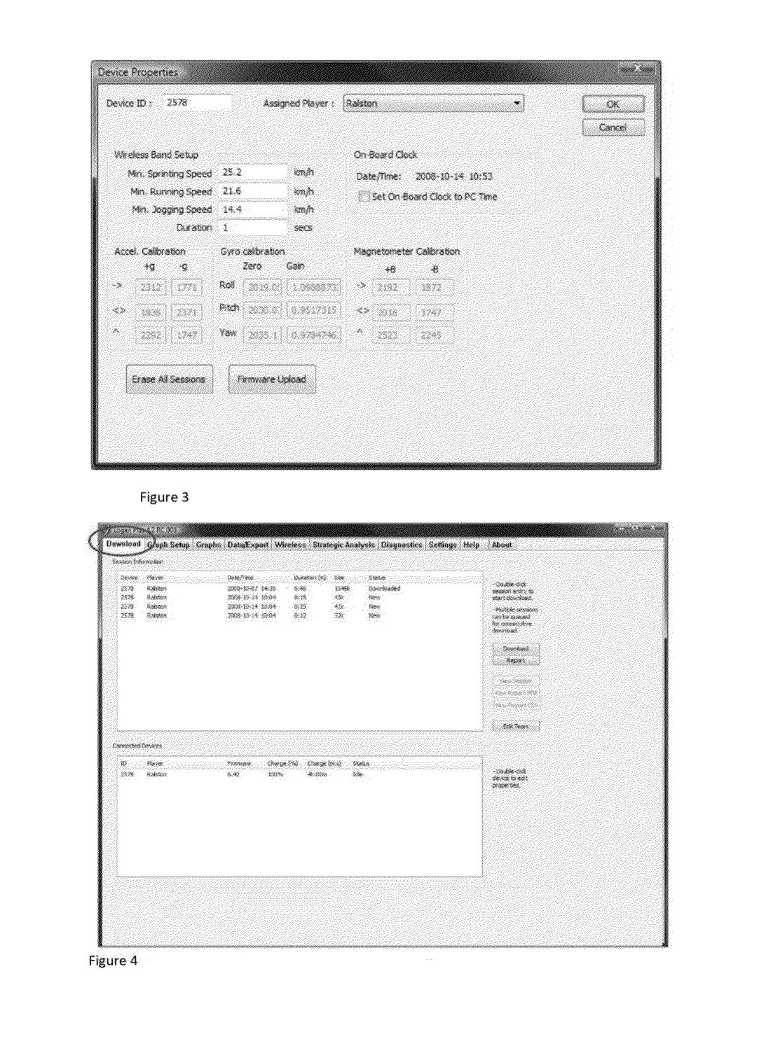

The properties configuration screen of FIG. 3 enables each participant monitor to be custom configured for each player. For each device a different definition may be set up for:
Jogging
Running
Sprinting

This means that during a wireless analysis, on a supervising laptop or portable computer, the transmitted values for number of sprints, and sprint distance will be dependent on this definition. This is useful when players in a team are of different types, and there is a need to individualize their measurements.

This setup has no effect on post training analysis (i.e. when manipulating and analysing a downloaded file on a computer). These definitions are setup from the download tab by right clicking an a monitor. The configuration parameters include:
calibration values for each sensor linked to or in the monitor
the date and time
device ID and player ID
erasing previous sessions.
   Under performance settings the band table values are configured for:
Velocity
Accelerations
Heart Rate

For each band enter a low and high value. A minimum effort duration may also be defined; efforts must exceed this value before they are recorded as valid efforts

Work and rest definitions may also be included. This may be available for live (wireless data collection to a supervising computer device.

To upload data the monitor is connected with the computer and the software screen as shown in FIG. 4 is selected and the download tab is activated. The software allows data from the selected monitors to be saved into a raw data file.

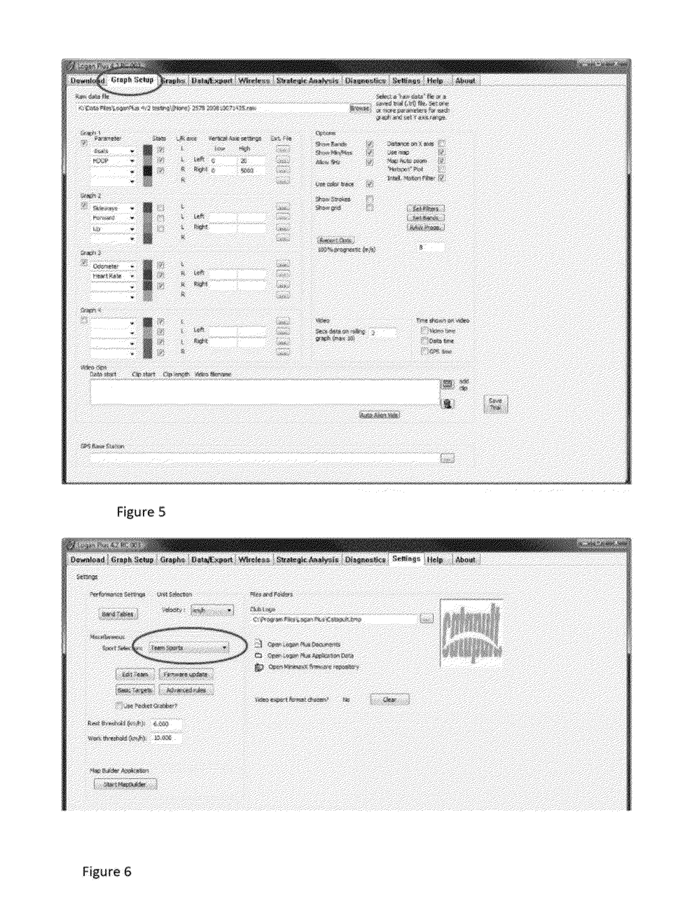

The session may be viewed by selecting the graph setup tab as shown in FIG. 5 and uploading the selected data files for the monitors of interest.

In the settings page as shown in FIG. 6 the graph may be customised to the sport of interest. In this case the example is Australian rules football.

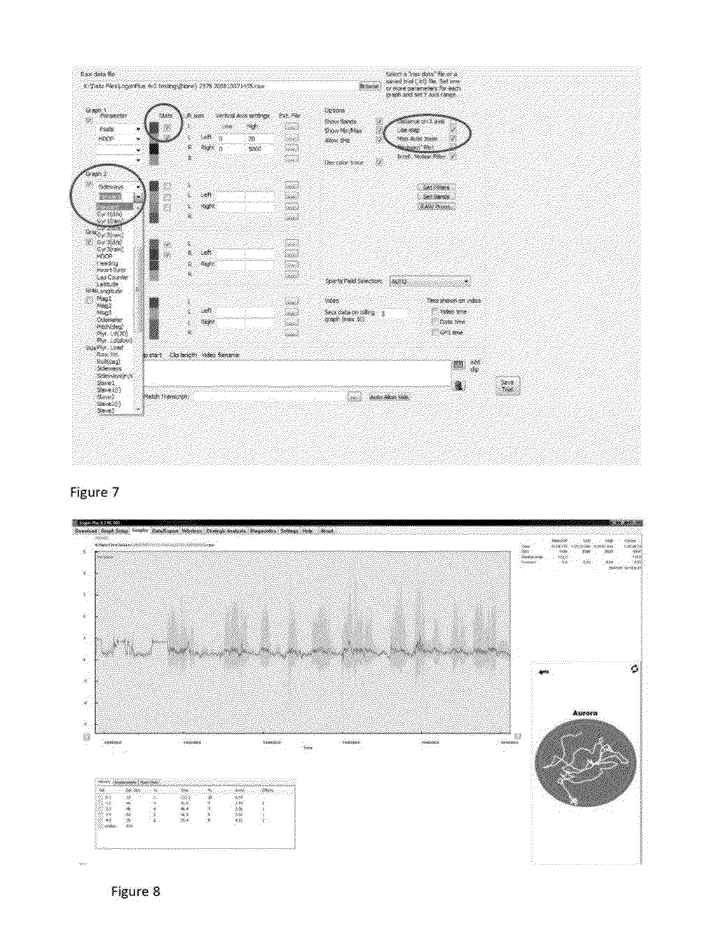

Then returning to the graph setup page as shown in FIG. 7 the parameter dropdown box is activated and Forward selected and the forward accelerometer trace is displayed on the graph. There are many parameters that may be selected.

By selecting the “use map” item and clicking on the graph tab a single graph of forward acceleration for a participant is displayed as shown in FIG. 8. The map displays the route taken by the player in the time interval of the graph. The map is adapted for different sports stadiums which is part of the library of data used by the software. A participant monitor may be used with its GPS location signal to map the perimeter of a new playing field to be added to the library.

The library will also include a list of sports and a list of player positions for each sport to combine with the player identity information.

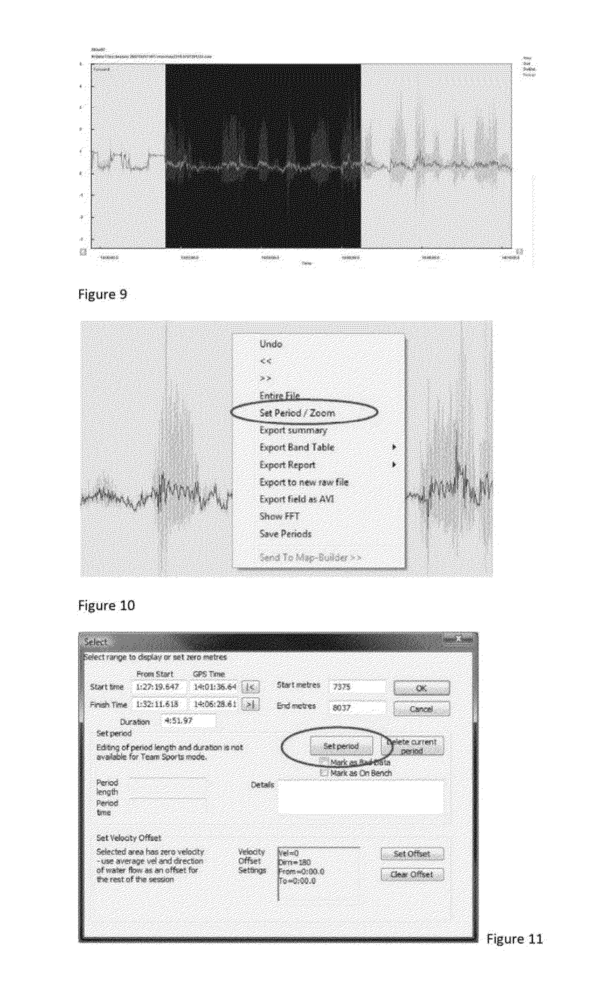

The time interval of interest is selected as shown in FIGS. 9, 10, and 11.

This then provides a screen similar to that of FIG. 8 for the selected time interval.

Particular periods of play may be highlighted and tagged to allow for quick viewing of the data for that period. The graph screen also has left right tabs for moving from one time interval to the next. The same time periods may be selected for multiple players so that graphical displays for more than one player may be viewed at the same time.

The data as presented for a set time period is then able to be analysed and used to generate reports.

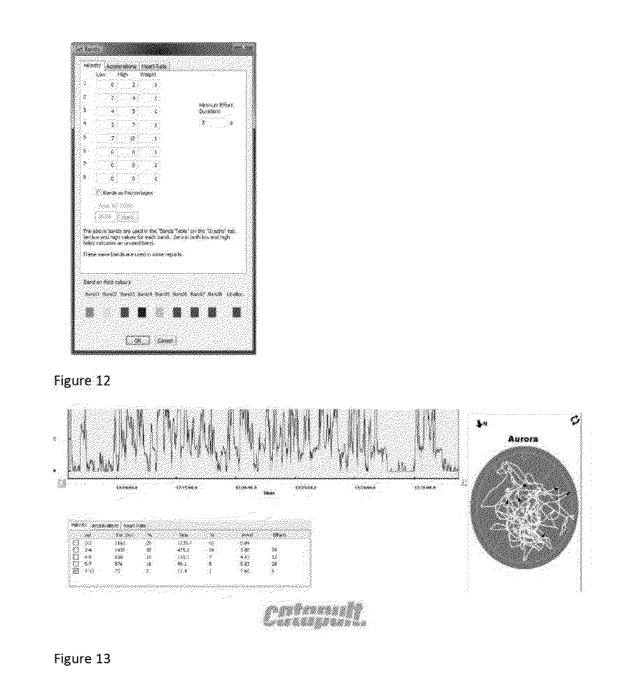

The example shown in FIGS. 12 and 13 is to select velocity bands for an individual player. In FIG. 12 the set bands tab is selected and the limits for the players speed in a selected range are chosen.

The results from the band tables selected can be seen at the bottom of the graphs in FIG. 13. Time and distance for each band is shown, as well as the number of efforts in each band. There is a check box beside each band. If selected, each of the efforts will be marked on the GPS map plot to show you where it has occurred (the tail of the arrow is at the start of the effort, and head of the arrow is where the effort finished). To generate reports this band table may be exported to a clip board for presentation in a spread sheet or word processor program. The report may be presented in any desired format.

The map of player movements may be presented as a heat map on the playing field indicating where the player spent most of the time in the interval presented. Rest times when the player was interchanged may be shown as well as time on the field when the player was inactive.

Tabulated data may include:
velocity bands and the time spent in each band
effort and efforts length in metres or time in each velocity band
effort starting accelerations broken into different acceleration bands
the efforts in any band may be analysed for recovery times.

The following is a list of parameters which can be selected for display or graphing in the Graph Setup page of Logan. Their availability to the user depends on which sport is chosen.

| | |
|---|---|
| #Sat | Number of satellites being used for the GPS solution |
| Ac3HR | Quadrant graph derived from Ac3Diff and imported Polar heart rate file |
| AcFlt1(g)-AcFlt(3)g | Internal dummy variables which hold pre-filtered variables for certain |
| | sports. You can also use them to hold filtered versions of variables you |
| | might create with the filtering options. |
| Acc(dpr) | Doppler based GPS acceleration. This is based on the rate of change |
| | of Doppler velocity from the GPS engine. |
| Altitude | Altitude based on GPS |
| AoA | Angle of Attack or the difference between the direction you are moving |
| | and direction you are facing (in degrees) |
| Dist(dgps) | no longer used. |
| Estimated XY | Not used |
| Facing | Direction the athlete is facing based on magnetometer and gyroscope |
| | information |
| Fig of Merit | GPS diagnostic. A low figure of merit implies a better GPS fix |
| Forward | Forward - Backwards accelerometry (g) |
| Gyr1(d/s:) | Angular velocity in degrees/second (Roll) |
| Gyr1(raw) | Angular velocity in raw a/d units (Roll) |
| Gyr2(d/s) | Angular velocity in degrees/second (Pitch) |
| Gyr2(raw) | Angular velocity in raw a/d units (Pitch) |
| Gyr3(d/s) | Angular velocity in degrees/second (Yaw) |
| Gyr3(raw) | Angular velocity in raw a/d units (Yaw) |
| HR% | Percentage heart rate (percentage of max when max has been defined for |
| | a player) |
| HDOP: | Horizontal dilution of precision - indicates accuracy of GPS solution in a |
| | horizontal plane |
| Heading | GPS beading in degrees |
| Heart Rate: | heart rate |
| Lap Counter | |
| Latitude | GPS latitude |
| Longitude | |
| Mag1 | Magnetometer 1 |
| Mag2 | Magnetometer 2 |
| Mag3 | Magnetometer 3 |
| Odometer | Distance travelled for the session. |
| Pitch(deg) | Angular displacement for rowing. This is continuously corrected towards |
| | the running average for the boat (Pitch direction). |
| Plyr.Ld(2D) | Player Load accumulated with the vertical accelerometer information |
| | omitted. This is an experimental parameter intended to show emphasise |
| | player load components that are “non running” related |
| Plyr.Ld(Acc) | accumulated athlete effort/loading based on accelerometer signals (see |
| | “Plyr. Load”) |
| Plyr.Ld(Slow) | Player Load accumulated when the athletes velocity is less than 2 m/s |
| | based on GPS velocity. This is an experimental parameter intended to |
| | show emphasise player load components that are “non running” related |
| Plyr. Load | Player Load is instantaneous rate of change of acceleration according to |
| (player load) | the formula Square Root ((acc-fwd\hat{ }2 + acc-side\hat{ }2 + acc-up\hat{ }2) divided by a |
| | scaling factor. The scaling factor is to reduce the value to about 100-200 for |
| | a full football match, thereby making it easier to work with (as opposed to |
| | a number in the millions) |
| | For some sports it is pre-filtered with a 6 hz cutoff Butterworth filter |
| | (swimming, running, halfpipe, moguls, canoeing). |
| | This parameter has been developed at the AIS as a metric for measuring |
| | effort. It has some advantages over using distance as an effort metric |
| | because it accumulates during tackles, ruck work, or other non distance |
| | activities. However for an athlete whose main activity is running, there will |
| | be a strong correlation between distance covered and Player Load. This is |
| | because the heel strike force generates vertical accelerations which feed |
| | into the Player Load formula. |
| Roll(deg) | Angular displacement for rowing. This is continuously corrected towards |
| | the running average for the boat (Roll direction). |
| Sideways | Left - Right accelerometry (g) |
| Slave1(r) . . . Slave8(r) | used for additional sensor inputs |
| Slave1 . . . Slave8 | used for additional sensor inputs |
| Smooth Vel. | Doppler velocity which has been filtered with a moving average filter |
| Spin | Sum of angular velocities on 3 axes (Running mode) |
| StkMark | select to mark strokes or strides on the graph for running, swimming, |
| | rowing |
| Stride | Stride rate in “strides per sec” (Running mode) |
| Tackle Load | Indicates the intensity of effort or exertion during an event that the |
| | software has marked as a tackle |
| Up | Up-down accelerometry (g) |
| VDOP | Vertical dilution of precision - indicates accuracy of GPS solution in a |
| | vertical plane |
| Vel/Stk | Velocity per stroke (Rowing) |
| VHi/Stk | Highest velocity within stroke |
| VLo/Stk | Lowest velocity within stroke |
| Vel % | Velocity as a percentage of max for a player (when this has been defined in |
| | the player database). |
| Vel(dop) | Velocity based on GPS Doppler shift (at 1 or 5 Hz depending on the |
| | minimaxX configuration). This is the main measure of velocity in the |
| | software and is generally used for effort/band table calculations |
| Vel(av) | Average of the last 5 GPS velocity readings. |
| Yaw(deg) | Angular displacement for rowing. This is continuously corrected towards |
| | the running average for the boat (Yaw direction). |
| AirAngle | total angle of rotation in a snowboarding trick calculating during an air |
| Turns | number of turns in moguls |

The software is preferably enabled to filter erroneous data. The software uses accelerometer and GPS information to filter the data and remove erroneous GPS information.

For example, when a player is sent to the interchange bench which may be concrete, the GPS reception may be very poor. As a result, the GPS position and velocity may ‘wander’ giving erroneous data. However the Intelligent Motion Filter is able to determine that the player is not moving and therefore discount this information.

The Intelligent Motion Filter also filters out data that shows poor GPS reception (HDOP>2.5) in combination with excessive velocity (>10 m/s).

When the IMF is switched on, the odometer (which tracks distance), the GPS map, the effort counter and the velocity bands will all ignore data which the filter has identified as suspect.

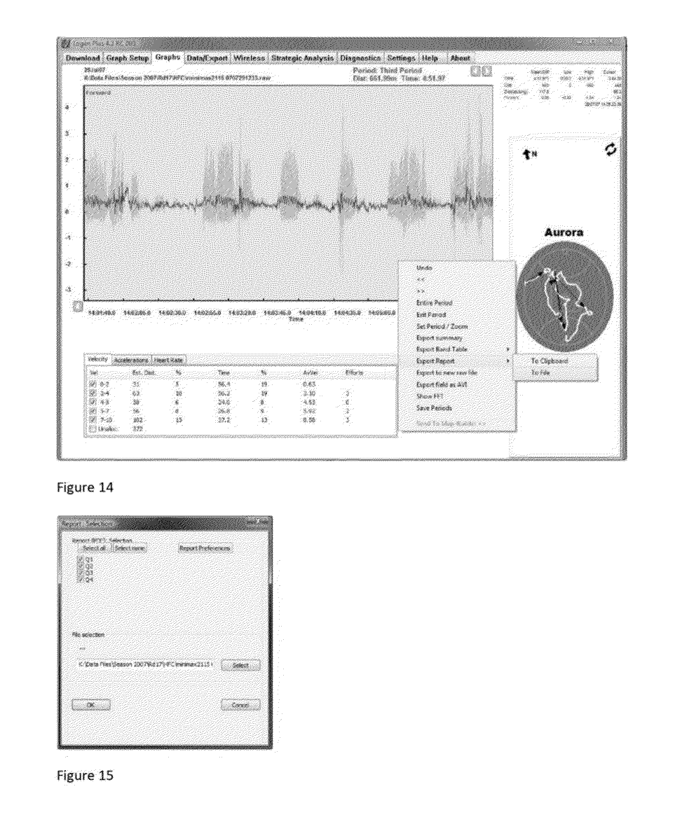

It is also possible to generate reports directly from the Wireless screen as shown in FIGS. 14 and 15. This report will display the current on-screen wireless statistics, totaled for each period and for the entire match. To export the wireless report, tight click anywhere on the wireless screen and select ‘Export Quarter Reports to . . . ’ then select the desired report format.

For wireless operation at a game or during training sessions a base station comprising an antenna and computer is used.

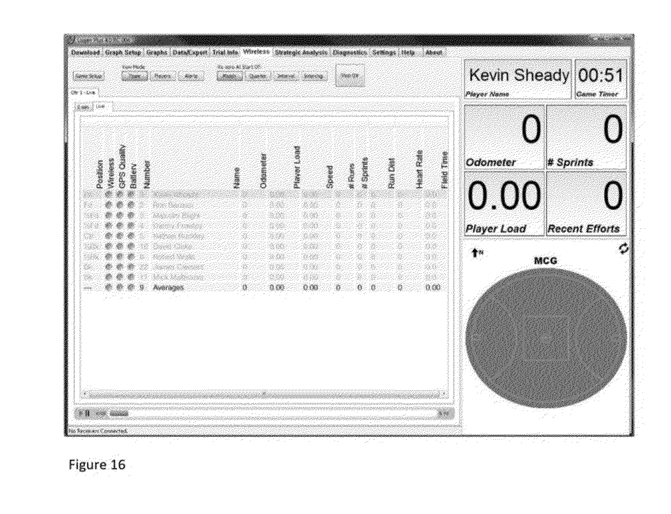

Comparison of players during an interval in a game or training session may be made by using a screen layout of the type shown in FIG. 16. Multiple metrics are displayed for multiple players. A list of players, jumper numbers, position, etc., is on the left part of the page. One row is highlighted in yellow. This corresponds to the player shown in large font at the top right of the screen. The purpose of the large font display is to improve view-ability in bright light conditions outside (e.g. sunlight). The coach may scroll through the players using the up and down arrows on the keyboard.

The antenna is as shown in FIG. 17. The receiver should be mounted so the centre of the tube is at head height preferably with a tripod. The side indicated by the arrow faces the area where the participants are active. At the bottom of the antenna is a USB cable for connection to the computer running the system software. Avoid placing the receiver at a location where people will frequently be standing in front of it (for instance runners in an AFL match). This will reduce the range of the receiver.

In wireless mode the signals from a participant monitor will send signals to the base station when the GPS signal is locked onto the monitor. A status message will appear on the screen as well. The signals from a monitor will be seen on the wireless screen of the base station or supervising monitor displayed as a row of data in the wireless page, and a white dot on a green field in the right of the page.

When the player is moving, a white trail will appear on the GPS map so that the players position for the previous several seconds may be seen.

In order to properly setup the wireless functionality for a particular game or training session, click “Game Setup” under the Wireless tab Game Setup allows the creation and editing of team settings and also provides for the saving and replay of matches.

The Team settings include:
Participant monitor Identification
   Unit being worn by the player
Player Details
   Name, Number and Position
   Basic Rules
   Advanced Rules
   The colour to be used when showing player position on ground

The Display Field check boxes allow the selection of parameters to be shown on the wireless screen.

Game Details are entered and the field is chosen. The selected field will be shown on the Wireless screen during a wireless session or replay. When players are on the field, wearing participant monitors, an animation of them moving around the field will be displayed on the supervisors screen. Each player is designated by a dot with a jumper number above it. A white trace shows the player position for the last 10 seconds. The ground may be rotated by clicking on the rotate icon in the animation frame. The animation may be enlarged or shrunk by clicking and dragging on the boundary of the frame.

The basic and advanced rules set parameter ranges for each parameter and enable alerts to be sent when the set parameters are exceeded or not met in set time interval.

Performance targets can be set and monitored for athletes during wireless sessions. The system is based around the use of Basic and Advanced rules and a Wireless viewing mode called the Alerts view. To modify a Basic Rule, select the desired player, the Basic Rules configuration for the selected player will then be displayed. Each of the Basic Rules statistics available for editing is a Wireless statistic.

To edit a rule, select the parameter from the parameter screen. As an example Odometer is to be edited. Any existing values for the selected rule will be presented. From this window, new values may be entered. In this example, the Odometer is an accumulating parameter. The window length is set at 120 seconds, so it is a Rule that the athlete travels between 100 m and 500 m in the last 120 seconds, or an alert will be raised. If no Window Length was set, then the Rule would be that the athlete travels between the upper and lower limit since the beginning of the match. The Odometer is set to zero at the beginning of a match. This example uses the Mid-band limit; there is a low limit AND a high limit. The rule method buttons are used to select mid-band, high or low limits.

In another example Speed is an instantaneous, non-accumulating parameter. Lower limit is selected as the rule method. The window length is set at 120 seconds, so it is a Rule that the average speed of the athlete in the last 120 seconds is equal to or above 0.5 m/sec, or an alert will be triggered. If no Window Length was set, then the Rule would be that if the instantaneous speed of the athlete moves outside the limit set (e.g. the athlete stands still) an alert will be triggered.

If a player has not met his performance target for the last period of play, his name maybe highlighted in red, and the performance target he has missed will also be highlighted.

Any parameter rules may be set up in this way. To determine if some team members need a rest alarms or alerts may be set if upper limits on odometer, heart rate, player load or tackle load for example are exceeded.

To see more details on this player, the coach may scroll to this name in the list, and press the space bar on the keyboard. He can then see this player statistics, for each period and interval of play. In this view you can move between players by using the right or left arrow on the keyboard.

The wireless page also enables replay of any portion of the current session and create bookmarks to mark features of interest. At the bottom of the page a timeline with play and pause buttons is displayed. A green line represents all the time wireless information has been connected during the session. Clicking somewhere along the line, will replay that portion of the wireless session. Clicking the play button will start replay.

In some sports players frequently come on or off the interchange bench. To capture this in the wireless session, the keyboard up or down arrows (or the mouse) are used to move to the player of interest and the player will be benched. All his performance stats will be frozen at this point and the alerts will be disabled. Activating a keyboard button will unfreeze the data. The time intervals for benching are captured by the software for later analysis. The line representing that particular player in the Wireless screen, and his dashboard statistics will change colour to indicate that player is currently off the field.

In wireless mode and on the field, supervisor monitors may be any suitable portable computer or handheld computing device including Apple® iPhone® or iPhone touch pads. Using the VNC (Virtual Network Computing) protocol it is possible to remotely view another computer over a network connection. With the base station PC running the system software it is also connected to a local WiFi network and is running a VNC server application, such as ReaIVNC for Windows. The iPhone is connected to the same local WiFi network and has a VNC viewer application installed, such as MochaVNC lite. The system software screen will appear on the handheld device. The iPhone zoom and pan controls may be used to obtain the desired view. It may be necessary to alter the window size of the system software screen on the PC to obtain the best possible view.

The data files down loaded by the system software may be synchronised with statistical files and video files. These files may form part of the stored data files of the system and may be common files accessed over the internet by a range of users.

The strategic analysis tool is very powerful for match play analysis, Often the official video footage shows what is happening around the ball in a team sport, and the coach is interested in the structure and movement of the rest of the players out of sight of the video.

With this tool the coach may view a GPS animation of the players movements while the video is scrolling. The coach may use stats files like a table of contents, to quickly move to periods of play which are of interest.

The addition of participant monitor data graphs may help the coach assess parameters such as heart rate or impact acceleration during relevant passages of play.

There are several ways of synchronizing video and data files. Through frequent use of the technology, coaches may develop their own preferred method.

One way is to film the participant monitor being switched on. Then leave the video tape running for the entire trial. When synchronizing in the supervisor software, the start of the data file will correspond to the point in the video where the device is switched on.

A second method is to use a characteristic accelerometer signal. For example, the coach may film an athlete jumping on the spot at the beginning or end of a training session. This results in a distinct accelerometer trace associated with the impact of the athlete upon landing. Once familiar with the data in the application, the files can be synchronised from inspection of the data rather than requiring some specific activity like jumping on the spot.

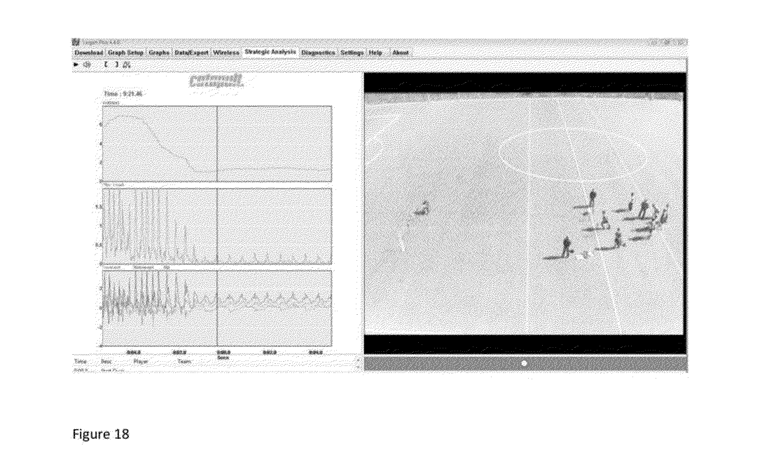

The synchronization process is usually iterative. An approximate time is added to the software, then the video synchronization is viewed frame by frame. By noting the video time displayed in the top left corner of the s video replay page, and the time axis on the data graphs, an estimate can be made of how far out of synch the two files are. The offset times are then adjusted in the graph set up page. The result is illustrated in FIG. 18.

In this page, the coach may use the spacebar on the keyboard to play and pause. The left and right arrows may advance the data one second at a time, the up and down arrows may be used to advance more quickly.

The circular arrow button in the top right hand corner of the animation window may be used to re orient the GPS plot to correspond with the angle of the vision. Each click rotates the ground by 90 degrees.

The divider bars between each of the 4 parts of the page may be clicked and dragged to provide more or less screen space to each one.

By returning to the Graph setup page, a stats file in an xml format may be used. Synchronisation of the stats file, participant monitor data and video may be performed using the “Automatically align vids” button in Graph Setup. This typically takes the start of match signal from the stats file, the video and the beginning of the first period set up in the participant monitor file and aligns them.

In other cases the coach will have to manually align the 3 data sources.

By setting up a stats file and returning to Strategic Analysis, the coach may double click on a stats transaction and have the video and data jump to that point.

Alternatively, the coach may right click and bring up a filtering tool for the stats enabling him to only view goals, or stoppages or events involving a particular player.

Strategic analysis is also possible on a whole team level. This allows for video footage of the game to be synchronised with the data displayed in the wireless screen, the game statistics file and the players position on the playing field from GPS.

The data and graphics generated by the system software is also suitable for broadcasting and may be combined and synchronised with video footage of the game to enhance the viewer's experience of the game.

From the above it can be seen that the present invention provides a unique system for assisting coaches and sports teams provide data to measure performance,

Those skilled in the art will also realise that the present invention may be implemented in embodiments other than those shown.

1. A system for monitoring a plurality of individuals engaged in sporting activity the system comprising:
a base station;
a plurality of individual monitors, carried on the person of each individual configured to communicate wirelessly with the base station;
a plurality of sensors, each sensor in communication with an individual monitor, each configured to be coupled to an individual and each sensor configured to sense a characteristic of the individual and to transmit, during the activity, data indicative of the characteristic to the individual monitor;
a group monitoring device configured to communicate wirelessly with the base station;
wherein each individual monitor is configured to transmit, during the activity, the data to the base station;
wherein the base station is configured to receive the data and to transmit during the activity a metric based on the data to the group monitoring device; and
wherein the group monitoring device is configured to display a representation of the metric.

2. The system as claimed in claim 1 wherein the sensors comprise one or more of 3 dimensional accelerometers, 3 dimensional gyrometers, magnetometers, GPS sensors, heart rate monitors.

3. The system of claim 1 wherein each individual monitor is further configured to transmit during the activity a metric based on the data to the base station.

4. The system of claim 1 wherein the base station is further configured to transmit during the activity the data to the group monitoring device.

5. The system of claim 4 wherein the group monitoring device is further configured to display a representation of the data.

6. The system of claim 1 wherein the plurality of individual monitors are configured to communicate bi-directionally with the base station.

7. The system of claim 1 wherein the data is indicative of at least one selected from the group consisting of: heart rate, speed, distance traveled, acceleration, location, orientation and heading of the individual.

8. The system of claim 1 wherein the metric is indicative of heart rate, speed, distance traveled, acceleration, location, orientation, heading, energy expenditure, power output and performance effectiveness of the individual.

9. The system of claim 1 further comprising a camera configured to obtain image information related to individuals and to transmit the image information to the base station during the activity wherein the data comprises the image information.

10. The system of claim 1 wherein the base station comprises a base station database and is configured to store at least one of the data and a metric in the base station database.

11. The system of claim 10 wherein the base station database includes a threshold value of a metric of a first individual.

12. The system of claim 11 wherein the base station is configured to transmit a notification to the group monitoring device in response to a metric for the first individual crossing the threshold value.

13. The system of claim 11 wherein the threshold value comprises a range and wherein the base station is configured to transmit a notification to the group monitoring device in response to a metric of the first individual being outside the range.

14. The system of claim 1 further comprising a web server system comprising:
a server data base, the web server system being configured to receive the metric from the base station and to store the metric in in the server database;
wherein the webserver system is configured to make the metric available to external analysis devices;
wherein the base station is further configured to transmit the metric to the web server.

15. The system of claim 14 wherein the web server system is further configured to receive a video feed.

16. The system of claim 15, wherein the base station is further configured to trans it the video feed to the web server system.

17. The system of claim 1 wherein an individual monitoring device of the plurality of individual monitoring devices is configured to calculate metric based on the data.

18. The system of claim 1 wherein the base station is further configured to calculate a metric based on the data.

19. The system of claim 4 wherein the group monitoring device is further configured to calculate a metric based on the data.

20. A system for monitoring a plurality of individuals engaged in a sporting activity the system comprising:
a base station;
a plurality of individual monitors, configured to communicate wirelessly with the base station;
a plurality of sensors, each sensor in communication with an individual monitor, each configured to be coupled to an individual and each sensor configured to sense a characteristic of the individual; and
a group monitoring device configured to communicate wirelessly with the base station.

21. The system of claim 20 wherein the base station portable.

22. The system of 20 wherein the base station further comprises a plurality of docking stations configured to provide power to the individual monitors when coupled thereto.

23. The system of claim 20 wherein the base station further comprises a plurality of docking stations and wherein the base station is configured to receive data from an individual monitor of the plurality of individual monitors via a wired connection when the individual monitor is coupled to a docking station of the plurality of docking stations.

24. The system of claim 20, wherein the base station further comprises a detachable battery.

25. The system of claim 20, wherein the base station further comprises antennas for wireless communications.

26. The system of claim 20 wherein the individual monitors are portable relative to the base station.

27. The system of claim 20 wherein the group monitoring device is portable relative to the base station.

28. The system of claim 20 wherein each individual monitor is configured to be coupled to an individual.

29. A method for facilitating monitoring of a plurality of individuals engaged in an athletic activity the method comprising:
receiving at a first individual monitoring device first data indicative of a characteristic of a first individual during an athletic activity of the first individual and a second individual wherein the first individual monitoring device is coupled to the first individual;
receiving at a second individual monitoring device second data indicative of a characteristic of the second individual during the athletic activity wherein the second individual monitoring device is coupled to the second individual;
transmitting the first data and the second data wirelessly to a base station during the athletic activity; and
determining at the base station a metric of the first individual and a metric of the second individual based on the first data and the second data respectively;
transmitting the metric of the first individual and the metric of the second individual wirelessly to a group monitoring device during the athletic activity; and
displaying a representation of the metrics on the group monitoring device;
wherein the group monitoring device is portable relative to the base station.

30. The method of claim 29 further comprising storing at the base station the metric of metric of the first individual and the metric of the second individual.

31. The method of claim 29 further comprising:
determining, at the first individual monitoring device during the athletic activity, a metric of the first individual based on the first data;
determining, at the second individual monitoring device during the athletic activity, a metric of the second individual based on the second data;
transmitting during the athletic activity, the metric of the first individual determined at the first individual monitoring device and the metric of the second individual determined at the second individual monitoring device, to the base station.

32. The method of claim 29 further comprising transmitting the first data and the second data wirelessly to the group monitoring device during the athletic activity.

33. The method of claim 29 further comprising displaying a representation of the data on the group monitoring device.

34. The method of claim 29 wherein the data is indicative of at least one selected from the group consisting of: heart rate, speed, distance traveled, acceleration, location, orientation and heading of the individual.

35. The method of claim 29 wherein the metric is indicative of heart rate, speed, distance traveled, acceleration, location, orientation, heading, energy expenditure, power output and performance effectiveness of the individual.

36. The method of claim 29 further comprising transmitting a notification to the group monitoring device in response to a metric for the first individual crossing the threshold value.

37. The method of claim 29 further comprising transmitting a notification to the group monitoring device in response to a metric for the first individual being outside a determined range.

38. The method of claim 29 further comprising transmitting the metric of the first individual and the metric of the second individual to a web server system.

39. The method of claim 38 further comprising transmitting a video feed of the athletic activity to the web server system.

40. A system for monitoring a plurality of individuals engaged in a sporting activity the system comprising:
a portable base station;
a plurality of individual monitors, carried on the person of each individual configured to communicate with the base station, each individual monitor being portable with respect to the base station;
a plurality of sensors, each sensor in communication with an individual monitor, each configured to be coupled to the individual and each sensor configured to sense a characteristic of the individual and to transmit, during the activity, data indicative of the characteristic to the individual monitor;
a group monitoring device in communication with the base station and portable with respect to the base station;
wherein each individual monitor is configured to transmit, during the activity, the data to the base station;
wherein the base station is configured to receive the data and to transmit during the activity a metric based on the data to the group monitoring device;
wherein the group monitoring device is configured to display a representation of the metric;
wherein the base station is portable with respect to the activity site.

41. A group monitoring device comprising:
a display configured to display during an athletic activity a plurality of individual performance metrics relating to a plurality of individuals engaged in the athletic activity, each individual performance metric relating to one of the plurality of individuals; and
an input to manipulate the display.

42. The group monitoring device as claimed in claim 41 wherein the display is further configured to display a group performance metric relating to one more than one of the plurality of individuals.

43. The device of claim 42 wherein the group performance metric is based at least in part on the individual performance metrics of a subset of the plurality of individuals.

44. The device of claim 41 wherein the individual performance metric comprises heart rate.

45. The device of claim 41 wherein the individual performance metric comprises speed.

46. The device of claim 41 wherein the individual performance metric comprises distance traveled.

47. The device of claim 41 wherein the individual performance metric comprises location.

48. The device of claim 41 wherein the individual performance metric comprises orientation.

49. The device of claim 41 wherein the individual performance metric comprises energy expenditure.

50. The device of claim 41, wherein the individual performance metric comprises power output.

51. The group monitoring device as claimed in claim 41 wherein the display is configured to display a first plurality of performance metrics relating to a first individual.

52. The device as claimed in claim 51 wherein the display is further configured to display a second plurality of performance metrics relating to a second individual.

53. The device of claim 52 wherein the second plurality of performance metrics is the same as the first plurality of metrics.

54. The device of claim 52 wherein one of the second plurality of performance metrics is displayed with emphasis relative to the balance of the second plurality of performance metrics.

55. The device of claim 41 wherein the display is configured to display identification information of each individual in association with a set of corresponding individual performance metrics.

56. The device of claim 55 wherein the set of corresponding individual metrics is the same for each individual.

57. The device of claim 55 wherein the set of corresponding individual metrics is the different for at least two individuals.

58. The device of claim 41 wherein the input is a touch screen.

59. A method for monitoring a plurality of individuals engaged in an athletic activity, comprising:
displaying during the athletic activity a plurality of individual performance metric information relating to a plurality of individuals engaged in the athletic activity, each performance metric relating to one of a plurality of individuals;
providing first and second analysis markers adapted to be manipulated by a user to define a subset of the displayed performance metric information as a function of an interval parameter; and
displaying performance metric information corresponding only to a subset of the displayed performance metric information defined by the analysis markers for each of a plurality of individuals.

60. The method of claim 59 wherein the interval parameter comprises time.

61. The method of claim 59 wherein the interval parameter comprises distance.

62. The method of claim 59 wherein the first and second analysis markers define a portion of the athletic activity.

63. The method of claim 59 wherein the portion of the athletic activity is a conditioning drill.

64. The method of claim 59 wherein the portion of the athletic activity a strength training drill.

65. The method of claim 59 wherein the portion of the athletic activity is a skills drill for a particular sport.

66. The method of claim 59 wherein the displaying is in response to user manipulation during the activity.

67. The method of claim 59 wherein the displaying is in response to user manipulation before the activity.

68. The method of claim 59 further comprising alerting the user that a performance metric has exceeded a threshold.

69. A computer program product comprising a computer-usable medium having computer program logic recorded thereon that, when executed by one or more processors, provides to a user performance information related to an athletic activity engaged in by a plurality of individuals, the computer program logic comprising:
first computer readable program code that enables a processor to display during the athletic activity a plurality of individual performance metric information relating to a plurality of individuals engaged in the athletic activity, each performance metric relating to one of the plurality of individuals;
second computer readable program code that enables a processor to provide first and second analysis markers adapted to be manipulated by a user to define a subset of the displayed performance metric information as a function of an interval parameter; and
third computer readable program code that enables a processor to display performance metric information corresponding to only the subset of the displayed performance metric information defined by the analysis markers for each of the plurality of individuals.

70. A group monitoring device for monitoring a plurality of individuals engaged in an athletic activity, the device comprising:
a display configured to display during an athletic activity:
a metric relating to each of a plurality of individuals engaged in the athletic activity; and
a status of a system component used to monitor the athletic activity; and
an input configured to allow manipulation of the display.

71. The device of claim 70 wherein the system component is a component remote from the display.

72. The device of claim 70 wherein the system component is a base station.

73. The device of claim 70 wherein the system component is an individual monitor.

74. The device of claim 70 wherein the system component is an object monitor.

75. The device of claim 70 wherein the system component is a sensor in communication with an individual monitor.

76. The device of claim 70 wherein the system component is a sensor in communication with an object monitor.

77. The device of claim 70 wherein the status is an indication of remaining battery power of a battery of the system component.

78. The device of claim 77 wherein the system component is a base station.

79. The device of claim 77 wherein the system component is an individual monitor coupled to an individual engaged in the athletic activity.

80. The device of claim 77 wherein the system component is an object monitor coupled to a sports object.

81. The device of claim 77 wherein the status is an indication of a number of remote monitors docked at the base station.

82. The device of claim 77 wherein the status is an indication of a GPS signal strength at a remote monitor.

83. The device of claim 82 wherein the remote monitor is an individual monitor coupled to an individual engaged in the athletic activity.

84. The device of claim 82 wherein the system component is an object monitor coupled to a sports object.

85. The device of claim 70 wherein the status is an indication of proper operation of the system component.

86. The device of claim 70 wherein the status is an indication of proper placement of the system component.

87. The device of claim 70 wherein the status is displayed in response to the status passing a system alert threshold.

88. The device of claim 70 wherein the displayed status corresponds to an alert indication on a remote monitor.

89. The device of claim 70 wherein the status of a system component associated with an individual is displayed simultaneously with a performance metric relating to the individual.

90. A method for monitoring a plurality of individuals engaged in an athletic activity, the method comprising:
displaying during the athletic activity, a plurality of metrics relating to a plurality of individuals engaged in the athletic activity; and
displaying during the athletic activity a status of a system component used to monitor the athletic activity.

91. A computer program product comprising a computer-usable medium having computer program logic recorded thereon that, when executed by one or more processors, provides to a user performance information related to an athletic activity engaged in by a plurality of individuals, the computer program logic comprising:
first computer readable program code that enables a processor to display during the athletic activity a plurality of metrics relating to a plurality of individuals engaged in the athletic activity; and
second computer readable program code that enables a processor to display during the athletic activity a status of a system component used to monitor the athletic activity.

92. A group monitoring device for monitoring a plurality of individuals engaged in an athletic activity, the device comprising:
a display configured to display during the athletic activity a plurality of metrics relating to a plurality of individuals engaged in the athletic activity, each metric relating to one of the plurality of individuals; and;
an input configured to allow manipulation of the display;
wherein a metric of the plurality of metrics is a relative metric; and
wherein the relative metric provides an indication of a level of performance of its associated individual, relative to personal ability of the associated individual.

93. The device of claim 92, wherein the relative metric provides an indication of relative power of the associated individual, and wherein relative power is an indication of power output of the associated individual relative to a personal reference power output of the associated individual.

94. The device of claim 92, wherein the relative power metric associated with the associated individual is displayed simultaneously with a relative power metric associated with a second associated individual.

95. A method for monitoring a plurality of individuals engaged in an athletic activity, the method comprising:
displaying during the athletic activity, a plurality of metrics elating to a plurality of individuals engaged in the athletic activity, each metric relating to one of the plurality of individuals;
wherein a metric of the plurality of metrics is a relative metric; and
wherein the relative metric provides an indication of a level of performance of its associated individual, relative to personal ability of the associated individual.

96. The method of claim 95 further comprising determining a reference value for the relative metric based on a calibration assessment activity; wherein the relative metric is based on the reference value.

97. A computer program product comprising a computer-usable medium having computer program logic recorded thereon that, when executed by one or more processors, provides to a user performance information related to an athletic activity engaged in by a plurality of individuals, the computer program logic comprising:
computer readable program code that enables a processor to display during the athletic activity a plurality of metrics relating to a plurality of individuals engaged in the athletic activity, each metric relating to one of the plurality of individuals;
wherein a metric of the plurality of metrics is a relative metric; and
wherein the relative metric provides an indication of a level of performance of its associated individual, relative to personal ability of the associated individual.
